(19) United States
(12) Patent Application Publication
(10) Pub. No.: US 2003/0192208 A1
(43) Pub. Date: Oct. 16, 2003

(54) Wall-mounted calendar frame with a custom insert

(76) Inventor: William Billing, Cedar Hill, TX (US)

Correspondence Address: Michael L. Diaz, Michael L. Diaz, P.C., Suite 200, 555 Republic Drive, Plano, TX, 75074, US

(21) Appl. No.: 10/411,866

(22) Filed: Apr. 10, 2003

Related U.S. Application Data
(60) Provisional application No. 60/371,853, filed on Apr. 12, 2002.

(51) Int. Cl. G09D 3/02

(52) U.S. Cl. 40/122

(57) ABSTRACT

A wall-mounted calendar frame with custom inserts is disclosed. The wall-mounted calendar frame includes a frame bordering a transparent layer. On a back portion of the frame is a holding rack for holding a calendar insert. The calendar insert depicts a specific month and provides a decorative graphical representation. The calendar insert may be easily removed by a tab located on one side of the calendar insert. The frame may also be decorated with designs.

### RELATED APPLICATIONS

This utility application claims the priority date of Provisional Patent Application Serial No. 60/371,853 filed Apr. 12, 2002 and is hereby incorporated by reference.

### BACKGROUND OF THE INVENTION

1. Technical Field of the Invention

This invention relates to calendars, and more particularly, to wall-mounted calendar frame with a custom insert.

2. Description of Related Art

For many years, calendars have been used in offices and residences to provide a reference for many people. Typically, calendars take the form of a spiral bound calendar. The use of such calendars is widespread in a variety of different settings. However, it is not unusual to see a beautifully decorated office having a calendar mounted to a wall with a nail. Although unsightly, many people require a graphic representation of the month within their view. Such calendars may include photographs, drawings and other graphics in a unique fashion. However, the use of these calendars, although useful, is oftentimes quite unsightly.

Other types of calendars that are utilized include desk calendars in a wide variety of designs. These desk calendars are positioned on a desk providing a readily visible reference by a person sitting at the desk. Although these desk calendars typically are not as unsightly as the wall-mounted calendars, they still take up valuable space on the desk and are usually only visible by the person sitting at the desk. In addition, these desk calendars, as well as the wall-mounted calendars, do not accentuate or enhance the decor of a room.

Review of existing calendars reveals no disclosure or suggestion of a wall-mounted decorative calendar which accentuates and enhances the decor of a room. It is an object of the present invention to provide such an apparatus.

### SUMMARY OF THE INVENTION

In one aspect, the present invention is a wall-mounted calendar. The wall-mounted calendar includes a frame having a plurality of segments bordering a display area and a back surface. In addition, the wall-mounted calendar includes a holding rack mounted to the back surface of the frame and a plurality of calendar inserts. Each calendar insert has a decorative representation and a calendar representation. At least one of the plurality of calendar inserts is positioned within the holding rack and displayed within the display area of the frame. The frame is mounted to a wall to provide a decorative calendar display.

In another aspect, the present invention is a wall-mounted calendar. The wall-mounted calendar includes a frame having a plurality of segments bordering a display area and a back surface. A transparent layer is mounted flush against the back surface of the frame. The wall-mounted calendar also includes a holding rack mounted to the back surface of the frame. The holding rack has a perimeter border. A plurality of calendar inserts is positioned within the holding rack. The perimeter border of the holding rack provides constant pressure to a back surface of the plurality of calendar inserts. Each calendar insert has a decorative representation and a calendar representation. In addition, each calendar insert is associated with a specific month of the year and includes a tab for easy removal of a desired calendar insert from the holding rack. One of the calendar inserts of the plurality of calendar is displayed within the display area of the frame. The frame is mounted to a wall to provide a decorative calendar display.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a front view of a decorative wall-mounted calendar in the preferred embodiment of the present invention;

FIG. 2 is a front view of the wall-mounted calendar without a calendar insert;

FIG. 3 is a rear exploded perspective view of the wall-mounted calendar with the calendar insert removed from the wall-mounted calendar; and

FIG. 4 is a front perspective view of a plurality of calendar inserts removed from the wall-mounted calendar.

### DETAILED DESCRIPTION OF EMBODIMENTS

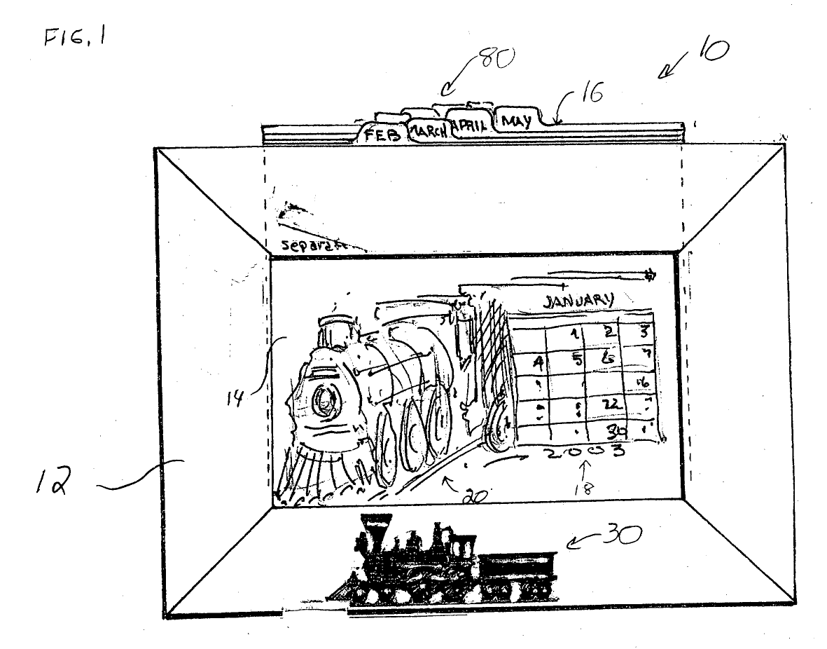

A wall-mounted decorative calendar is disclosed. FIG. 1 is a front view of a decorative wall-mounted calendar 10 in the preferred embodiment of the present invention. The wall-mounted calendar includes a frame 12 having a transparent layer 14 and a calendar insert 16. The calendar insert includes a calendar representation 18 and a decorative representation 20. As illustrated, the calendar representation is a depiction of a conventional monthly calendar. However, the calendar representation may be any depiction of a weekly, monthly or yearly calendar. In addition, the calendar representation may be removable from the calendar insert. The decorative representation 20 may be any visual representation, such as artwork, photograph, sketching, or drawings. In the preferred embodiment of the present invention, a plurality of monthly calendar inserts are positioned within the frame of the wall-mounted calendar. Each monthly calendar insert provides a different decorative representation. The plurality of calendar inserts preferably are for a specific year. However, in an alternate embodiment, one calendar insert is positioned behind the frame 12.

The decorative representations 20 may be of a specific theme, such as regional, seasonal, natural, occupational, industrial, historic, etc. Additionally, the frame may include one or more designs 30, providing additional themes for the wall-mounted calendar 10. The designs may be etched, affixed, drawn, or applied in any fashion to the frame. As depicted, the designs include a theme of a railroad company, however it should be understood that any design may be utilized. Alternatively, the frame may be without any design.

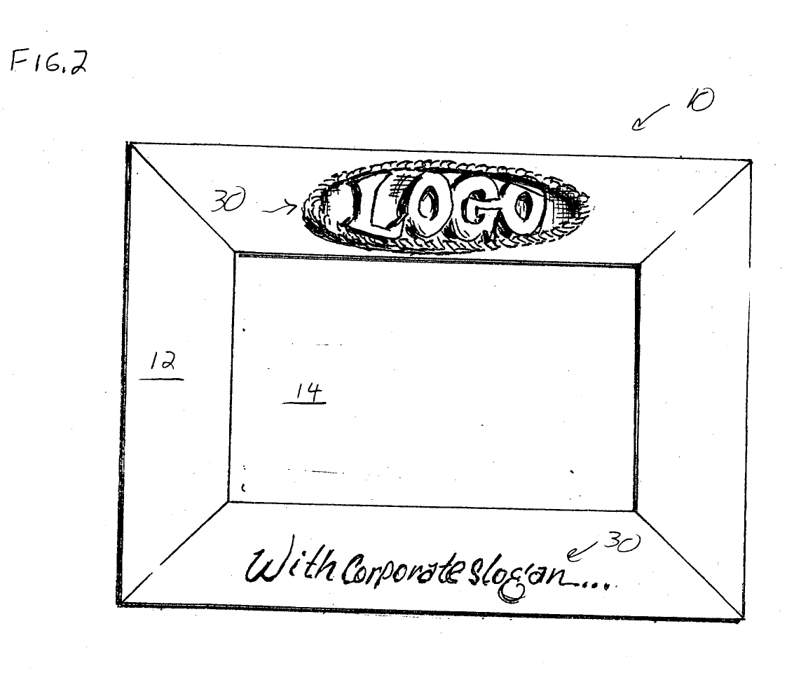

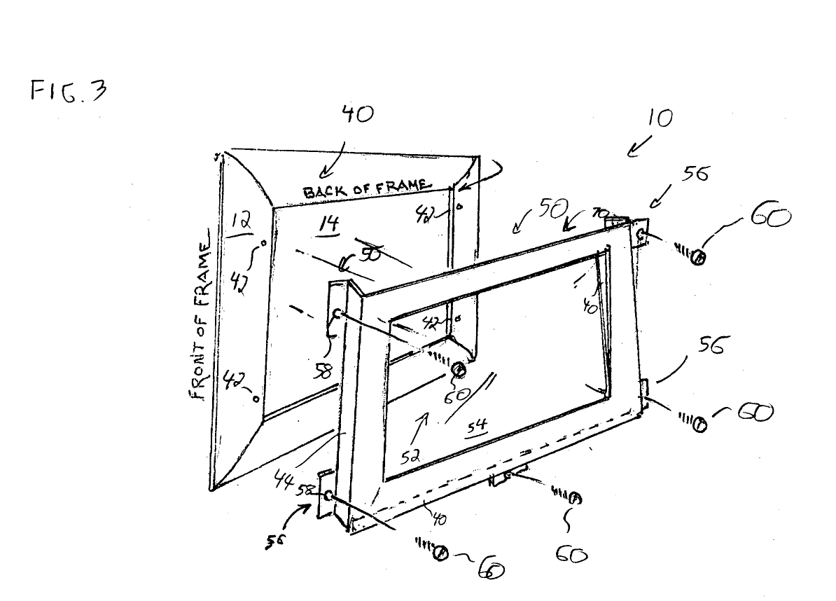

FIG. 2 is a front view of the wall-mounted calendar 10 without a calendar insert. The wall-mounted calendar, as discussed above, may include a design 30 mounted or affixed to the frame 12. The transparent layer 14 overlays the calendar insert 16 (not shown in FIG. 2). Preferably, the transparent layer is constructed of a non-glare material. FIG. 3 is a rear exploded perspective view of the wall-mounted calendar 10 with the calendar insert 16 removed from the wall-mounted calendar. The frame 14 may be any type of frame, having any dimension and shape. Preferably, the frame is constructed of a rigid material, such as wood or plastic. The transparent layer 14 is affixed to the frame, preferably against a back portion of the frame. As depicted in FIG. 3, the transparent layer is affixed against the back portion of the frame in such a manner as to provide a shallow rabbet. In an alternate embodiment of the present invention, the layer 14 may be translucent. Upon a back surface 40 of the frame is a plurality of holes 42.

A holding rack 50 is mounted to the back surface 40 of the frame 12. The holding rack includes a perimeter border 44 on a plurality of sides of the holding rack. The holding rack may include a back portion 52 or an opening 54 (shown in FIG. 3). The holding rack is mounted to the frame by a plurally of brackets 56. Each bracket may include an opening 58. The holding rack may then be affixed to the frame by a plurality of screws 60 positioned through the openings 58 and the holes 42, such as panhead screws.

The holding rack includes an open portion 70 allowing the positioning of the calendar insert 16 into the holding rack. As depicted in FIG. 3, the open portion is located on a top side of the holding rack. However, the open portion may be located on any segment of the frame, such as a side. The perimeter border is configured to allow a space (in both depth, width and height) large enough to accommodate at least one calendar insert 16. Additionally, the perimeter border provides constant pressure to a back surface of one or more calendar inserts positioned within the holding rack.

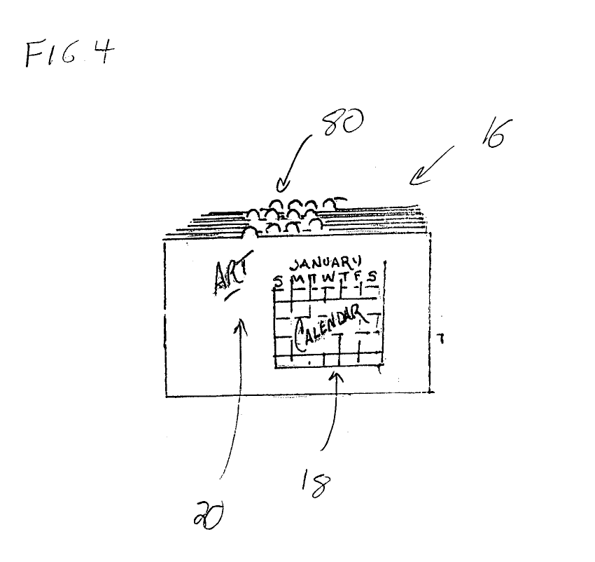

FIG. 4 is a front perspective view of a plurality of calendar inserts 16 removed from the wall-mounted calendar. The calendar inserts may include a tab 80 attached to at least one side of the calendar insert. The tab provides a holding point for removing and inserting the calendar insert into the holding rack 50. The tab is sized and positioned in such a fashion that it is obscured from view by the frame 12 when view from a front view. In addition, each tab is positioned in a slightly different position along the side of the calendar insert from other calendar inserts to allow easy selection of a desired calendar insert from a stack of calendar inserts.

With reference to FIGS. 1-4, the operation of the wall-mounted calendar 10 will now be explained. The wall-mounted calendar 10 is removed from a wall. A plurality of calendar inserts 16 are selected, each insert representing a specific month of the year. The plurality of calendar inserts is positioned within the holding rack 50 in such a manner that the decorative and calendar representations of the front calendar insert is visible from the front side of the wall-mounted calendar 10. The holding rack is affixed to the frame and holds the calendar inserts in position. The frame 12 may be mounted to any wall in a conventional manner as any picture frame, such as with a wire running horizontally from a back portion of the wall-mounted calendar, or a bracket for holding a nail. When the wall-mounted calendar is mounted to the wall, a decorative calendar is displayed on the wall. The calendar does not display any unsightly nails. Additionally, since the wall-mounted calendar is located on a wall, precious desk space is conserved. In alternate embodiments of the present invention, the holding rack 50 may be mounted in any manner to the frame 12, such as with an adhesive, snaps, etc. In addition, the holding rack may be configured in any manner which allows the easy removal and insertion of a calendar insert into the wall-mounted calendar 10. In addition, although one month is preferably displayed within the calender insert, a plurality of months may be displayed as desired by the user. When the current month is complete, the front calendar insert is grasped by the tab and removed, thereby displaying the next calendar insert depicting the now current month. The calendar representation may be optionally removed from the calendar insert, thus allowing the calendar insert to be used as a stand-alone display without a calendar reference.

In another alternate embodiment of the present invention, the wall-mounted calendar 10 may include a sound emitting device (not shown). The use of sound emitting devices are well known. Any device which emits a sound or series of sounds may be utilized. The sound emitting device may emit a musical rendition or a specific theme sound (e.g., natural such as the surf) associated with the decorative representation 20 or design 30. The sound emitting device may be mounted on a back portion of the wall-mounted calendar or along a side perimeter of the frame.

The present invention provides many advantages over existing calendars. The wall-mounted calendar provides an aesthetically pleasing appearance for the calendar. In addition, the wall-mounted calendar provides for easy insertion and removal of the calendar insert. Additionally, the wall-mounted calendar allows the user to change representations by changing the calendar inserts as desired. Different themes or scenes may be displayed. In addition, the frame allows the mounting of designs upon the frame itself.

It is thus believed that the operation and construction of the present invention will be apparent from the foregoing description. While the apparatus shown and described has been characterized as being preferred, it will be readily apparent that various changes and modifications could be made therein without departing from the scope of the invention as defined in the following claims.

What is claimed is:

1. A wall-mounted calendar, said wall-mounted calendar comprising:
a frame, said frame having a plurality of segments bordering a display area and a back surface;
a holding rack mounted to the back surface of said frame; and
a plurality of calendar inserts, each calendar insert having a decorative representation and a calendar representation;
whereby at least one of said plurality of calendar inserts is positioned within said holding rack and displayed within the display area of said frame, said frame being mounted to a wall to provide a decorative calendar display.

2. The wall-mounted calendar of claim 1 wherein said frame includes a layer within the display area.

3. The wall-mounted calendar of claim 2 wherein said layer is transparent.

4. The wall-mounted calendar of claim 2 wherein said layer is translucent.

5. The wall-mounted calendar of claim 2 wherein the layer is mounted flush against the back surface of the frame.

6. The wall-mounted calendar of claim 1 wherein said holding rack includes a perimeter border providing constant pressure to at least one of the calendar inserts positioned within the holding rack.

7. The wall-mounted calendar of claim 6 wherein one segment of the perimeter border is open to allow insertion and removal of at least one calendar insert.

8. The wall-mounted calendar of claim 1 wherein each calendar insert of said plurality of inserts is associated with a specific month of the year.

9. The wall-mounted calendar of claim 1 wherein each calendar insert includes a tab located on a side of each calendar insert, the tab allowing the grasping of a desired calendar insert and facilitating the removal of the calendar insert from the holding rack.

10. The wall-mounted calendar of claim 1 wherein the calendar representation is a depiction of a month.

11. The wall-mounted calendar of claim 1 wherein said frame includes a displayed design.

12. The wall-mounted calendar of claim 1 further comprising a sound emitting device emitting sounds from the wall-mounted calendar.

13. A wall-mounted calendar, said wall-mounted calendar comprising:
a frame, said frame having a plurality of segments bordering a display area and a back surface;
a transparent layer mounted flush against the back surface of the frame;
a holding rack mounted to the back surface of said frame having a perimeter border; and
a plurality of calendar inserts positioned within said holding rack, the perimeter border of said holding rack providing constant pressure to a back surface of said plurality of calendar inserts and each calendar insert having a decorative representation and a calendar representation, wherein each calendar insert of said plurality of calendar inserts is associated with a specific month of the year and includes a tab for easy removal of a desired calendar insert from said holding rack;
whereby said one of the calendar inserts of said plurality of calendar is displayed within the display area of said frame, said frame being mounted to a wall to provide a decorative calendar display.
